(19) United States
(12) Patent Application Publication
(10) Pub. No.: US 2011/0088982 A1
(43) Pub. Date: Apr. 21, 2011

(54) Lifting Device For An Overhead Projector Which Has A Constant Velocity During The Upward And Downward Movement

(76) Inventor: Kuo-Hua Chen, Taichung City (TW)

(21) Appl. No.: 12/902,246

(22) Filed: Oct. 12, 2010

(30) Foreign Application Priority Data
Oct. 15, 2009 (TW) 098219016

(51) Int. Cl. B66B 1/32

(52) U.S. Cl. 187/288

(57) ABSTRACT

A lifting device includes a lifting unit, a drive unit connected with the lifting unit to control operation of the lifting unit, and a braking unit connected with the drive unit to control operation of the drive unit. The braking unit includes a microprocessor, a control circuit connected with the microprocessor, a changeover switch connected with the control circuit and the drive unit, and a control switch connected with the microprocessor and the changeover switch. Thus, the drive unit is rotated normally in the positive direction to lift the overhead projector and is rotated at a slower speed in the reverse direction to lower the overhead projector so that the overhead projector is kept at a constant speed during the lifting and lowering process and is moved upward and downward smoothly and stably.

### BACKGROUND OF THE INVENTION

1. Field of the Invention

The present invention relates to a lifting device and, more particularly, to a lifting device for an overhead projector.

2. Description of the Related Art

A conventional lifting device for an overhead projector comprises a lifting unit and a drive unit connected with the lifting unit to control operation of the lifting unit. The lifting unit has an upper end mounted on the ceiling and a lower end mounted on an overhead projector. Thus, the drive unit is operated to drive the lifting unit so as to lift or lower the overhead projector. However, when the drive unit is operated in the positive direction to lift the overhead projector, the overhead projector is moved upward at a slower speed due to its weight, and when the drive unit is operated in the reverse direction to lower the overhead projector, the overhead projector is moved downward at a higher speed due to its gravity. Thus, the overhead projector is not kept at a constant speed during the lifting and lowering process so that the overhead projector is not moved smoothly and stably during the upward and downward movement.

### BRIEF SUMMARY OF THE INVENTION

In accordance with the present invention, there is provided a lifting device, comprising a lifting unit, a drive unit connected with the lifting unit to control operation of the lifting unit, and a braking unit connected with the drive unit to control operation of the drive unit. The braking unit includes a microprocessor, a control circuit connected with the microprocessor, a changeover switch connected with the control circuit and the drive unit, and a control switch connected with the microprocessor and the changeover switch. The control circuit of the braking unit includes a first transistor, a second transistor, a first connecting terminal and a second connecting terminal. The first transistor of the control circuit is connected with a power supply and is connected with the first connecting terminal. The second transistor of the control circuit is connected with a ground side and is connected with the second connecting terminal. The control switch of the braking unit includes a relay. The relay of the control switch has a coil connected with the microprocessor.

The primary objective of the present invention is to provide a lifting device for an overhead projector which has a constant velocity during the upward and downward movement.

According to the primary advantage of the present invention, the drive unit is rotated normally in the positive direction to lift the overhead projector and is rotated at a slower speed in the reverse direction to lower the overhead projector so that the overhead projector is kept at a constant speed during the lifting and lowering process and is moved upward and downward smoothly and stably.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a lifting device for an overhead projector in accordance with the preferred embodiment of the present invention.

FIG. 2 is a partially enlarged perspective view of the lifting device for an overhead projector as shown in FIG. 1.

FIG. 3 is a circuit diagram of the lifting device for an overhead projector as shown in FIG. 1.

FIG. 4 is a schematic operational view of the lifting device for an overhead projector as shown in FIG. 1 in use.

FIG. 5 is a front operational view of the lifting device for an overhead projector as shown in FIG. 4.

FIG. 6 is a circuit diagram of the lifting device for an overhead projector as shown in FIG. 5.

FIG. 7 is a front operational view of the lifting device for an overhead projector as shown in FIG. 4.

FIG. 8 is a circuit diagram of the lifting device for an overhead projector as shown in FIG. 7.

FIG. 9 is a circuit diagram of the lifting device for an overhead projector as shown in FIG. 1.

### DETAILED DESCRIPTION OF THE INVENTION

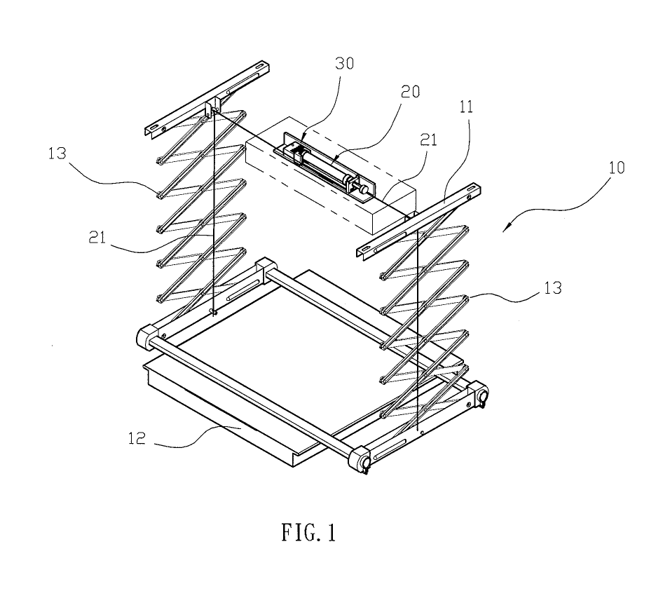

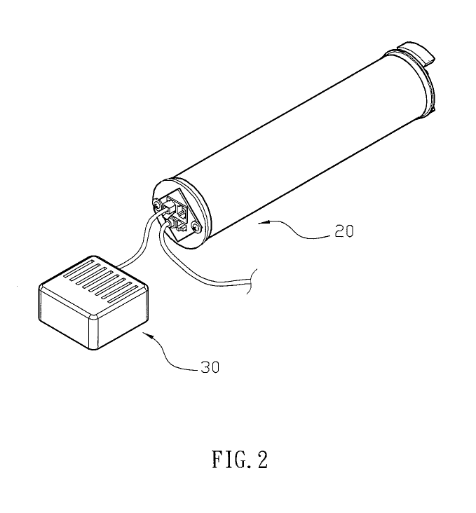

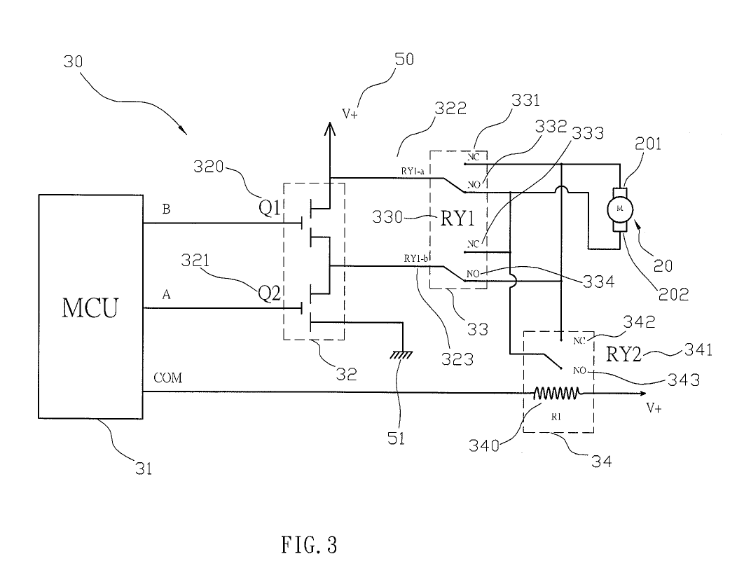

Referring to the drawings and initially to FIGS. 1-4, a lifting device for an overhead projector in accordance with the preferred embodiment of the present invention comprises a lifting unit 10, a drive unit 20 connected with the lifting unit 10 to control operation of the lifting unit 10, a braking unit 30 connected with the drive unit 20 to control operation of the drive unit 20, and a remote controller 35 connected with the braking unit 30 in a wireless manner to control operation of the braking unit 30.

The lifting unit 10 includes an upper frame 11, a lower frame 12 located under the upper frame 11 and two linking mechanisms 13 mounted between the upper frame 11 and the lower frame 12.

The drive unit 20 is mounted on the upper frame 11 of the lifting unit 10 and includes a lifting cord 21 which is extended through the upper frame 11 of the lifting unit 10 and connected with the lower frame 12 of the lifting unit 10 to move the lower frame 12 relative to the upper frame 11. The drive unit 20 has an input side 201 and an output side 202.

The braking unit 30 is mounted on the upper frame 11 of the lifting unit 10 and includes a microprocessor 31, a control circuit 32 connected with the microprocessor 31, a changeover switch 33 connected with the control circuit 32 and the drive unit 20, and a control switch 34 connected with the microprocessor 31 and the changeover switch 33.

The control circuit 32 of the braking unit 30 includes a first transistor 320, a second transistor 321, a first connecting terminal 322 and a second connecting terminal 323. The first transistor 320 of the control circuit 32 is connected with a power supply 50 and is connected with the first connecting terminal 322. The second transistor 321 of the control circuit 32 is connected with a ground side 51 and is connected with the second connecting terminal 323.

The changeover switch 33 of the braking unit 30 includes a relay 330. The relay 330 of the changeover switch 33 has a first normally closed terminal 331 connected between the first connecting terminal 322 of the control circuit 32 and the input side 201 of the drive unit 20 and has a first normally open terminal 332 connected between the first connecting terminal 322 of the control circuit 32 and the output side 202 of the drive unit 20 so that the first connecting terminal 322 of the control circuit 32 is selectively connected with the first normally closed terminal 331 and the first normally open terminal 332 of the changeover switch 33.

The relay 330 of the changeover switch 33 has a second normally closed terminal 333 connected between the second connecting terminal 323 of the control circuit 32 and the output side 202 of the drive unit 20 and has a second normally open terminal 334 connected between the second connecting terminal 323 of the control circuit 32 and the input side 201 of the drive unit 20 so that the second connecting terminal 323 of the control circuit 32 is selectively connected with the second normally closed terminal 333 and the second normally open terminal 334 of the changeover switch 33.

In practice, when the first connecting terminal 322 of the control circuit 32 is connected with the first normally open terminal 332 of the changeover switch 33, and the second connecting terminal 323 of the control circuit 32 is connected with the second normally open terminal 334 of the changeover switch 33, the first transistor 320 of the control circuit 32 has an operation time that is shorter than that of the second transistor 321. In addition, the first transistor 320 and the second transistor 321 of the control circuit 32 are not connected or disconnected simultaneously. Thus, when the first transistor 320 of the control circuit 32 is connected, the second transistor 321 of the control circuit 32 is disconnected, and when the second transistor 321 of the control circuit 32 is connected, the first transistor 320 of the control circuit 32 is disconnected.

The control switch 34 of the braking unit 30 is also connected with the drive unit 20. The control switch 34 of the braking unit 30 includes a relay 341. The relay 341 of the control switch 34 has a coil 340 connected with the microprocessor 31. The relay 341 of the control switch 34 also has a normally closed terminal 342 connected with the first normally closed terminal 331 of the changeover switch 33, the second normally open terminal 334 of the changeover switch 33 and the input side 201 of the drive unit 20 and has a normally open terminal 343 connected with the first normally open terminal 332 of the changeover switch 33, the second normally closed terminal 333 of the changeover switch 33 and the output side 202 of the drive unit 20.

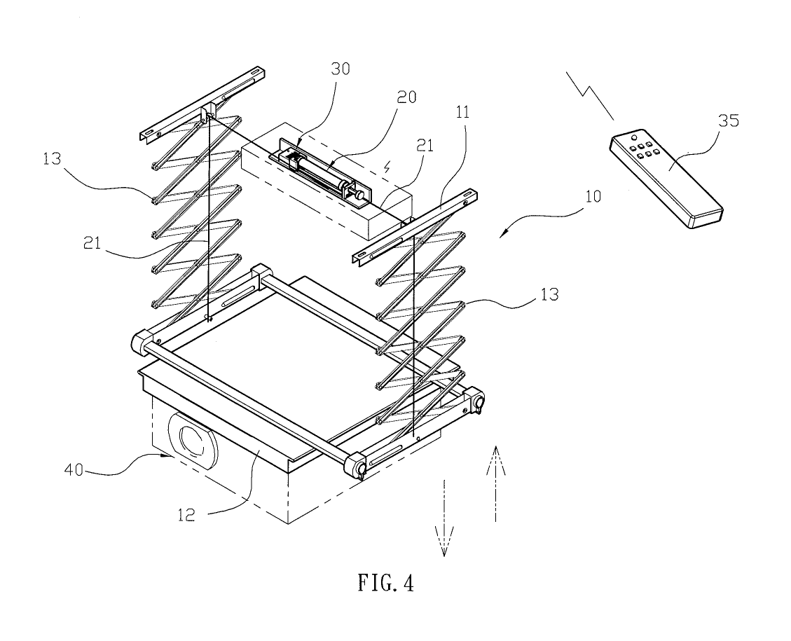

In operation, referring to FIG. 4 with reference to FIGS. 1-3, the upper frame 11 of the lifting unit 10 is mounted on a ceiling, and the lower frame 12 of the lifting unit 10 is mounted on an overhead projector 40. Thus, the braking unit 30 is driven by the remote controller 35 to drive the drive unit 20 which drives the lifting cord 21 to move the lower frame 12 relative to the upper frame 11 so as to lift or lower the overhead projector 40.

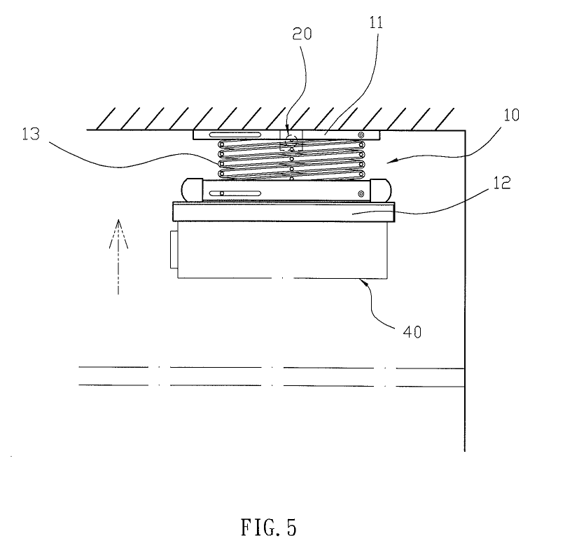

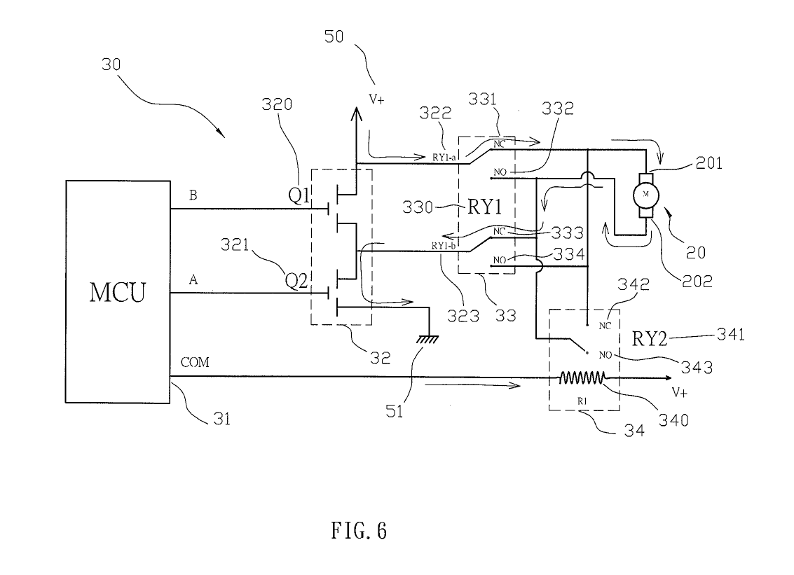

Referring to FIGS. 5 and 6 with reference to FIGS. 1-3, when the braking unit 30 receives a first signal (positive rotation signal) from the remote controller 35, the microprocessor 31 of the braking unit 30 sends a signal to the control switch 34 so that the relay 341 of the control switch 34 is excited to connect the normally open terminal 343 of the control switch 34 with the first normally open terminal 332 of the changeover switch 33, the second normally closed terminal 333 of the changeover switch 33 and the output side 202 of the drive unit 20. At the same time, the first connecting terminal 322 of the control circuit 32 is connected with the first normally closed terminal 331 of the changeover switch 33, and the second connecting terminal 323 of the control circuit 32 is connected with the second normally closed terminal 333 of the changeover switch 33. At the same time, the microprocessor 31 of the braking unit 30 also sends a signal to the control circuit 32 so that the second transistor 321 of the control circuit 32 is connected, the first transistor 320 of the control circuit 32 is disconnected. In such a manner, the current from the power supply 50 in turn flows through the first connecting terminal 322 of the control circuit 32, the first normally closed terminal 331 of the changeover switch 33, the input side 201 of the drive unit 20, the drive unit 20, the output side 202 of the drive unit 20, the second normally closed terminal 333 of the changeover switch 33, the second connecting terminal 323 of the control circuit 32 and the second transistor 321 of the control circuit 32 into the ground side 51 to form a complete circuit as shown in FIG. 6. Thus, the braking unit 30 is operated to drive the drive unit 20 which is rotated in the positive direction to drive the lifting cord 21 to move the lower frame 12 upward relative to the upper frame 11 so as to lift the overhead projector 40 as shown in FIG. 5.

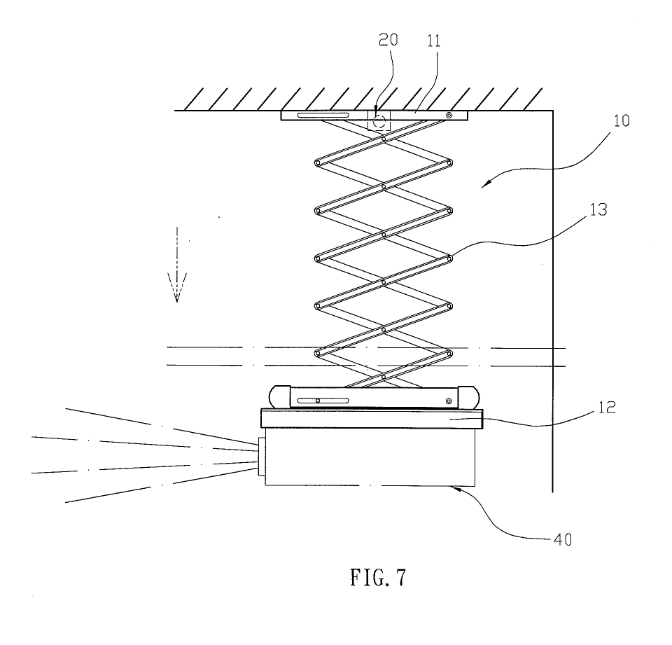

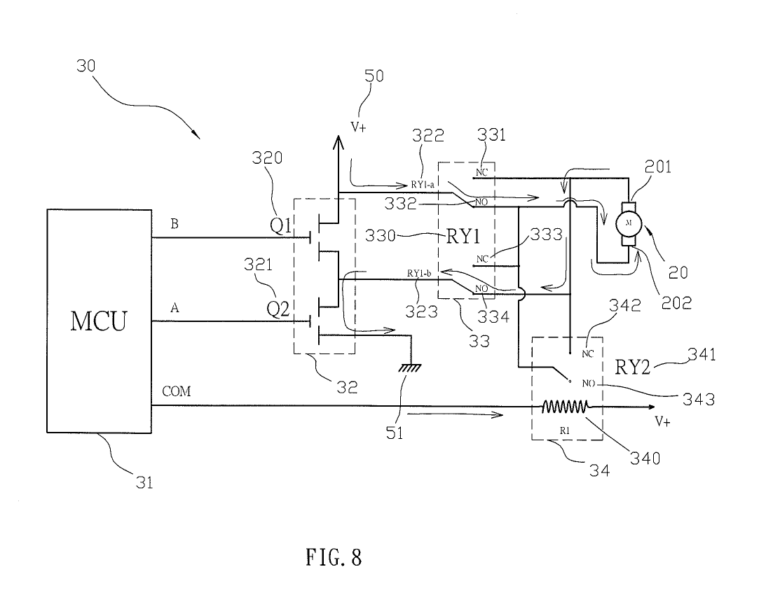

Referring to FIGS. 7 and 8 with reference to FIGS. 1-3, when the braking unit 30 receives a second signal (reverse rotation signal) from the remote controller 35, the microprocessor 31 of the braking unit 30 sends a signal to the control switch 34 so that the relay 341 of the control switch 34 is excited to connect the normally open terminal 343 of the control switch 34 with the first normally open terminal 332 of the changeover switch 33, the second normally closed terminal 333 of the changeover switch 33 and the output side 202 of the drive unit 20. At the same time, the first connecting terminal 322 of the control circuit 32 is connected with the first normally open terminal 332 of the changeover switch 33, and the second connecting terminal 323 of the control circuit 32 is connected with the second normally open terminal 334 of the changeover switch 33. At the same time, the microprocessor 31 of the braking unit 30 also sends a signal to the control circuit 32 so that the first transistor 320 and the second transistor 321 of the control circuit 32 are connected and disconnected in an alternating and intermittent manner. At this time, the first transistor 320 and the second transistor 321 of the control circuit 32 cannot be connected or disconnected simultaneously so that when the first transistor 320 of the control circuit 32 is connected, the second transistor 321 of the control circuit 32 is disconnected, and when the second transistor 321 of the control circuit 32 is connected, the first transistor 320 of the control circuit 32 is disconnected. In addition, the operation time of the first transistor 320 is shorter than that of the second transistor 321.

In such a manner, when the second transistor 321 of the control circuit 32 is connected and the first transistor 320 of the control circuit 32 is disconnected, the current from the power supply 50 in turn flows through the first connecting terminal 322 of the control circuit 32, the first normally open terminal 332 of the changeover switch 33, the output side 202 of the drive unit 20, the drive unit 20, the input side 201 of the drive unit 20, the second normally open terminal 334 of the changeover switch 33, the second connecting terminal 323 of the control circuit 32 and the second transistor 321 of the control circuit 32 into the ground side 51 to form a complete circuit as shown in FIG. 8. Thus, when the second transistor 321 of the control circuit 32 is connected and the first transistor 320 of the control circuit 32 is disconnected, the braking unit 30 is operated to drive the drive unit 20 which is rotated in the reverse direction to drive the lifting cord 21 to move the lower frame 12 upward relative to the upper frame 11 so as to lower the overhead projector 40 as shown in FIG. 7.

On the contrary, when the first transistor 320 of the control circuit 32 is connected and the second transistor 321 of the control circuit 32 is disconnected, the electrical connection between the power supply 50 and the ground side 51 is interrupted by the second transistor 321 of the control circuit 32 so that the drive unit 20 stops rotating. Thus, the drive unit 20 is rotated normally when the second transistor 321 of the control circuit 32 is connected and the first transistor 320 of the control circuit 32 is disconnected, and stops rotating when the first transistor 320 of the control circuit 32 is connected and the second transistor 321 of the control circuit 32 is disconnected, so that the rotation speed of the drive unit 20 is delayed and reduced in the reverse direction to match that of the drive unit 20 in the positive direction.

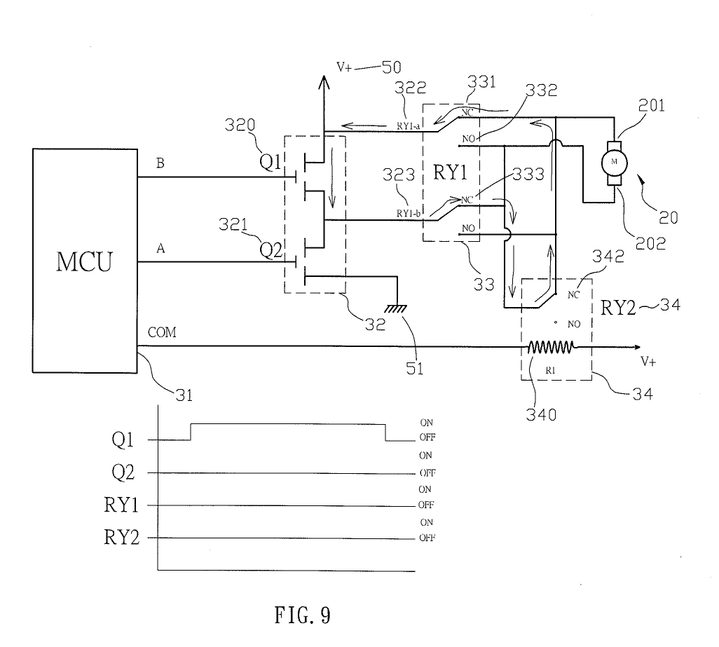

Referring to FIG. 9 with reference to FIGS. 1-3, the microprocessor 31 of the braking unit 30 sends a signal to the control switch 34 so that the relay 341 of the control switch 34 stops exciting to connect the normally closed terminal 342 of the control switch 34 with the first normally open terminal 332 of the changeover switch 33, the second normally closed terminal 333 of the changeover switch 33 and the input side 201 of the drive unit 20. At this time, the control switch 34 has a resistance much smaller than that of the drive unit 20 so that the current will not pass through the drive unit 20. In such a manner, the current from the power supply 50 in turn flows through the first transistor 320 of the control circuit 32, the second connecting terminal 323 of the control circuit 32, the second normally closed terminal 333 of the changeover switch 33, the normally closed terminal 342 of the control switch 34, the first normally closed terminal 331 of the changeover switch 33 and the first connecting terminal 322 of the control circuit 32 into the control circuit 32 so that the current will not pass through the drive unit 20. Thus, when the drive unit 20 is not operated during a long period of time, the current will not pass through the drive unit 20 so that the drive unit 20 is kept at a steady state.

Accordingly, the drive unit 20 is rotated normally in the positive direction to lift the overhead projector 40 and is rotated at a slower speed in the reverse direction to lower the overhead projector 40 so that the overhead projector 40 is kept at a constant speed during the lifting and lowering process and is moved upward and downward smoothly and stably.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A lifting device, comprising:
a lifting unit;
a drive unit connected with the lifting unit to control operation of the lifting unit; and
a braking unit connected with the drive unit to control operation of the drive unit;
wherein the braking unit includes:
a microprocessor;
a control circuit connected with the microprocessor;
a changeover switch connected with the control circuit and the drive unit; and
a control switch connected with the microprocessor and the changeover switch;
the control circuit of the braking unit includes a first transistor, a second transistor, a first connecting terminal and a second connecting terminal;
the first transistor of the control circuit is connected with a power supply and is connected with the first connecting terminal;
the second transistor of the control circuit is connected with a ground side and is connected with the second connecting terminal;
the control switch of the braking unit includes a relay;
the relay of the control switch has a coil connected with the microprocessor.

2. The lifting device of claim 1, wherein
the drive unit has an input side and an output side;
the changeover switch of the braking unit includes a relay;
the relay of the changeover switch has a first normally closed terminal connected between the first connecting terminal of the control circuit and the input side of the drive unit;
the relay of the changeover switch has a first normally open terminal connected between the first connecting terminal of the control circuit and the output side of the drive unit;
the first connecting terminal of the control circuit is selectively connected with the first normally closed terminal and the first normally open terminal of the changeover switch;
the relay of the changeover switch has a second normally closed terminal connected between the second connecting terminal of the control circuit and the output side of the drive unit;
the relay of the changeover switch has a second normally open terminal connected between the second connecting terminal of the control circuit and the input side of the drive unit;
the second connecting terminal of the control circuit is selectively connected with the second normally closed terminal and the second normally open terminal of the changeover switch;
when the first connecting terminal of the control circuit is connected with the first normally open terminal of the changeover switch, and the second connecting terminal of the control circuit is connected with the second normally open terminal of the changeover switch, the first transistor of the control circuit has an operation time that is shorter than that of the second transistor.

3. The lifting device of claim 2, wherein
the first transistor and the second transistor of the control circuit are not connected or disconnected simultaneously;
when the first transistor of the control circuit is connected, the second transistor of the control circuit is disconnected;
when the second transistor of the control circuit is connected, the first transistor of the control circuit is disconnected.

4. The lifting device of claim 2, wherein
the control switch of the braking unit is connected with the drive unit;
the relay of the control switch has a normally closed terminal connected with the first normally closed terminal of the changeover switch, the second normally open terminal of the changeover switch and the input side of the drive unit;
the relay of the control switch has a normally open terminal connected with the first normally open terminal of the changeover switch, the second normally closed terminal of the changeover switch and the output side of the drive unit.

5. The lifting device of claim 1, wherein
the lifting unit includes an upper frame, a lower frame located under the upper frame and two linking mechanisms mounted between the upper frame and the lower frame;
the drive unit is mounted on the upper frame of the lifting unit and includes a lifting cord which is extended through the upper frame of the lifting unit and connected with the lower frame of the lifting unit to move the lower frame relative to the upper frame.
the lifting device further comprises:
a remote controller connected with the braking unit in a wireless manner to control operation of the braking unit.
